(19) United States
(12) Patent Application Publication
(10) Pub. No.: US 2025/0258546 A1
(43) Pub. Date: Aug. 14, 2025

(54) TACTILE FEEDBACK DEVICE

(71) Applicant: POWERTIP TECHNOLOGY CORP., Taichung City (TW)

(72) Inventors: Shyh-Yueh WANG, Taichung City (TW); Chiu-Chung LIN, Taichung City (TW); Ching-Hsi LU, Taichung City (TW); Han-Lin CHEN, Taichung City (TW); Yen-Ming CHIANG, Taichung City (TW); Feng-Chang CHANG, Taichung City (TW); Hsiao-Ching CHEN, Taichung City (TW)

(21) Appl. No.: 18/438,183

(22) Filed: Feb. 9, 2024

(51) Int. Cl. G06F 3/01; G06F 3/041

(52) U.S. Cl. CPC G06F 3/016; G06F 3/0412; G06F 3/0414; G06F 2203/04105

(57) ABSTRACT

A touch sensor comprises two baseplates arranged at intervals, a first electrode disposed between the baseplates, and a pressure sensing module. Two-dimensional touch control of the sensor is achieved by the first electrode. An insulating material is provided between the module and the first electrode. The module comprises a second electrode based on the insulating material and disposed on a side of the insulating material away from the first electrode, and a third electrode disposed above the other one of the baseplates. The second electrode is not in contact with the third electrode, an air gap is provided between the second and third electrodes, the second and third electrodes are respectively connected to a signal output source. When one of the baseplates close to the second electrode is touched, the air gap changes a spacing to change a self-capacitance signal of the signal output sources.

### FIELD OF THE INVENTION

The present invention relates to an auxiliary device of a touch panel, and more particularly relates to a tactile feedback device for the touch panel.

### BACKGROUND OF THE INVENTION

A touch panel is a human-machine interface without keys, and touch areas or virtual keys may be customized on the panel according to different usage requirements, so that the usage requirements of various application configurations may be met. Moreover, the touch panel has the characteristics of being easy to clean and attractive in appearance and the like, and is widely applied to equipment such as an intelligent mobile phone, a tablet personal computer, an information guide machine, a ticket dispenser, and an automatic teller machine.

With regard to the touch areas or virtual keys of the touch panel, an operator may not know exactly whether a correct position is clicked and whether touching is completed. In order to be convenient for the operator to confirm whether the touch is completed, for the conventional touch panel, an actuator is disposed on a housing, the actuator serves as a tactile feedback device, and when the operator clicks the correct position and completes the touch, the actuator may vibrate to generate tactile feedback, so that the operator may know exactly that the touch is completed.

The conventional actuator is disposed on the housing of the touch panel, so that a vibration strength of the actuator is greatly attenuated after being transmitted to the touch panel, and especially for a large-sized touch panel, the vibration strength may be attenuated to a greater extent, so that the operator may not obviously feel the tactile feedback (the vibration strength), in other words, the operator may not confirm whether the touch is completed, thus causing troubles in use.

Therefore, for “display equipment” in Patent No. I796967B published in Taiwan, by utilizing a plurality of actuators and extensions of a back frame, vibration effects in a plurality of partitions are generated on a large-sized touch display panel, so that vibration feedback effects of the large-sized touch display panel may meet the requirements in use.

However, the more actuators are used, the more costs are incurred in manufacturing, control and maintenance, and there is also a problem of increase in energy consumption and weight, which obviously does not meet the requirements of lightening and miniaturization of equipment.

### SUMMARY OF THE INVENTION

A main object of the present invention is to provide a tactile feedback device which enables an operator to obviously feel feedback. The tactile feedback device may greatly reduce the number of actuators required, and achieve the same tactile feedback effect.

In order to achieve the above object, the present invention relates to a tactile feedback device mounted on a touch device with a touch panel and a housing, and the tactile feedback device includes an actuator and an elastic suspension supporting module. The actuator is fixed to the touch device and provides a vibration force with a vibration direction. The elastic suspension supporting module includes a plurality of elastic suspension supporting members respectively provided with a first end fixed to the touch panel and a second end fixed to the housing, and the plurality of elastic suspension supporting members are respectively provided with a buffering and resetting displacement degree of freedom with a displacement direction parallel to the vibration direction, and the plurality of elastic suspension supporting members support the touch panel in a symmetrical distribution.

In summary, the present invention prevents interference in vibration transmission from a structure supporting point by enabling the vibration direction of the vibration force to be the same as the displacement direction of the buffering and resetting displacement degree of freedom, may be avoid to enable the vibration force of the actuator to be uniformly transmitted to the touch panel, so that the operator may obviously feel tactile feedback vibration, and the requirements in use are met.

### BRIEF DESCRIPTION OF THE DRAWINGS

FIG. 1 is a schematic diagram showing appearance of a first example of the present invention.

FIG. 2 is a schematic diagram showing structure disassembly of the first example of the present invention.

FIG. 3 is a side schematic diagram showing a partial structure combination of the first example of the present invention.

FIG. 4 is a schematic diagram showing appearance of a second example of the present invention.

FIG. 5 is a schematic diagram showing a partial structure combination of the second example of the present invention.

FIG. 6 is a schematic diagram showing partial structure disassembly of the second example of the present invention.

FIG. 7 is a schematic diagram showing appearance of a third example of the present invention.

FIG. 8 is a schematic diagram showing partial structure disassembly of the third example of the present invention.

### DETAILED DESCRIPTION OF THE PREFERRED EMBODIMENTS

The detailed description and technical contents of the present invention will be described below in conjunction with the accompanying drawings.

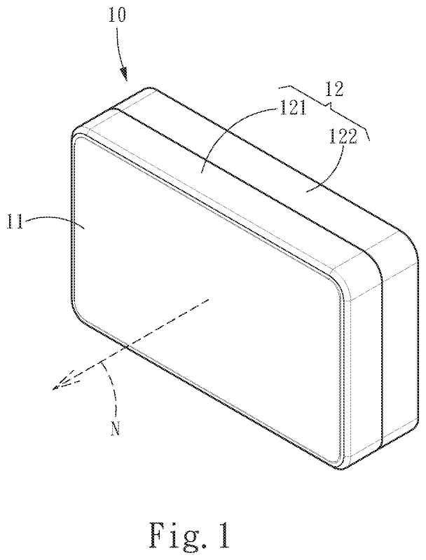

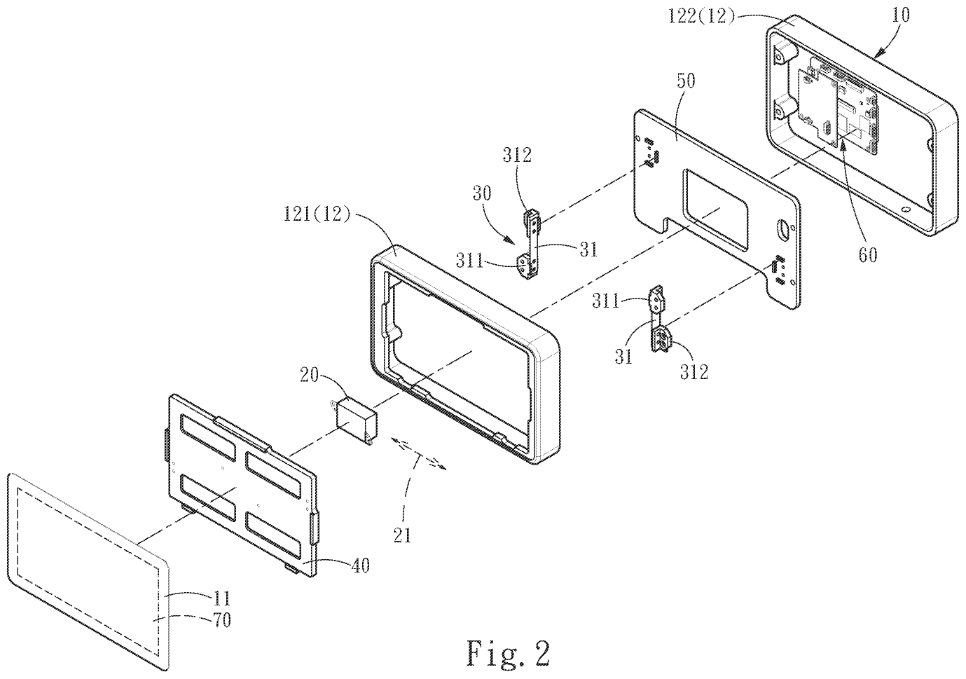

Referring to FIG. 1 and FIG. 2, a first embodiment of the present invention, disclosed a tactile feedback device mounted on a touch device 10 with a touch panel 11 and a housing 12. In this embodiment, the touch device 10 with a size of 7 inches is taken as an example for description. The housing 12 includes a frame 121 and a back cover 122, the touch panel 11 is disposed at a front side of the frame 121, a rear side of the frame 121 is covered by the back cover 122, and the touch panel 11 has a normal direction N.

The tactile feedback device includes an actuator 20 and an elastic suspension supporting module 30. The actuator 20 is fixed to the touch device 10, and more precisely, the actuator 20 is fixed to the touch panel 11. In one embodiment, the present invention further includes a first supporting member 40, wherein the first supporting member 40 is fixed to the touch panel 11 of the touch device 10, and the actuator 20 is fixed to the first supporting member 40, namely the actuator 20 is fixed to the touch panel 11 of the touch device 10 by the first supporting member 40. The first supporting member 40 is attached and fixed to the touch panel 11 in a large area, thereby protecting the touch panel 11. The actuator 20 also provides a vibration force with a vibration direction 21, and in this embodiment, the vibration direction 21 is perpendicular to the normal direction N. In one embodiment, the actuator 20 is selected from any one of an eccentric motor, a piezoelectric actuator, and a linear resonator, wherein the eccentric motor, the piezoelectric actuator, and the linear resonator may generate the vibration force with the vibration direction 21 after being driven.

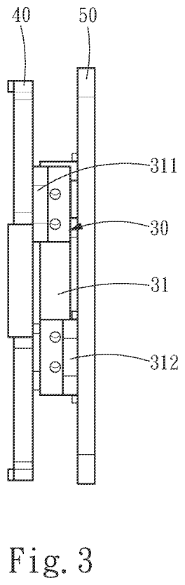

Referring to FIG. 2 and FIG. 3, the elastic suspension supporting module 30 includes a plurality of elastic suspension supporting members 31, the plurality of elastic suspension supporting members 31 respectively include a first end 311 and a second end 312, and first ends 311 of the plurality of elastic suspension supporting members 31 are fixed to the first supporting member 40, namely the first ends 311 are fixed to the touch panel 11 by the first supporting member 40. In one embodiment, the present invention further includes a second supporting member 50, wherein the second supporting member 50 is fixed to the housing 12, and second ends 312 of the plurality of elastic suspension supporting members 31 are fixed to the second supporting member 50, namely the second ends 312 are fixed to the housing 12 by the second supporting member 50, and a design of the second supporting member 50 may reduce difficulty in an assembly in practice.

The plurality of elastic suspension supporting members 31 are respectively provided with a buffering and resetting displacement degree of freedom with a displacement direction parallel to the vibration direction 21, and the plurality of elastic suspension supporting members 31 support the touch panel 11 in a symmetrical distribution by the first supporting member 40, so that the touch panel 11 is also provided with a buffering and resetting displacement degree of freedom parallel to the vibration direction 21. The plurality of elastic suspension supporting members 31 are elastic structures made of plastic, metal, or foam, or leaf springs. In this embodiment, the touch device 10 with a size of 7 inches belongs to a type of machine with a relatively small size, a number of the plurality of elastic suspension supporting members 31 is disposed for two and selected to adopt the leaf springs, meanwhile, the elastic suspension supporting members 31 are respectively disposed on two sides of relatively long edges of the touch panel 11, and support the touch panel 11 in a symmetrical distribution.

In addition, the present invention further includes a control module 60, wherein the control module 60 controls the actuator 20, and more precisely, the control module 60 may control a vibration mode, vibration time or vibration strength, and the like of the actuator 20.

In one embodiment, the control module 60 drives the actuator 20 based on a real tactile data, and the real tactile data is a vibration feedback data of a specific texture. More specifically, when the specific texture is displayed on a touch area of the touch panel 11 which is touched by an operator, if the control module 60 drives the actuator 20 based on the real tactile data, a vibration of the touch panel 11 may enable the operator to feel touching on the specific texture in a manner of virtual reality

In another embodiment, the control module 60 drives the actuator 20 based on a sensed data. The sensed data is generated by a sensing device 70 disposed on the touch panel 11. The sensing device 70 may be any one of an infrared light pressure sensor and a multi-axis accelerometer. A strength and a speed of touching and pressing by the operator may be felt by the sensing device 70 to generate a corresponding sensed data, so that the control module 60 may drives the actuator 20 based on the sensed data to generate corresponding tactile feedback. For example, when the touch panel 11 is touched and pressed by the operator forcefully, the control module 60 controls the actuator 20 to generate a relatively great vibration, and when the touch panel 11 is pressed by the operator gently, the control module 60 controls the actuator 20 to generate a relatively slight vibration.

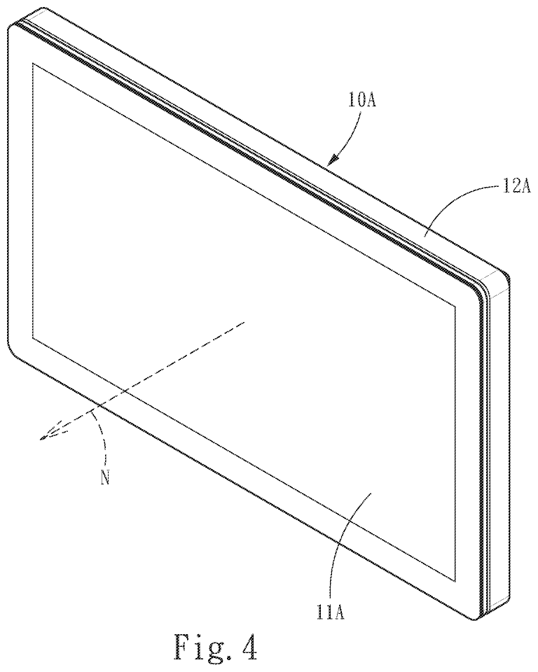

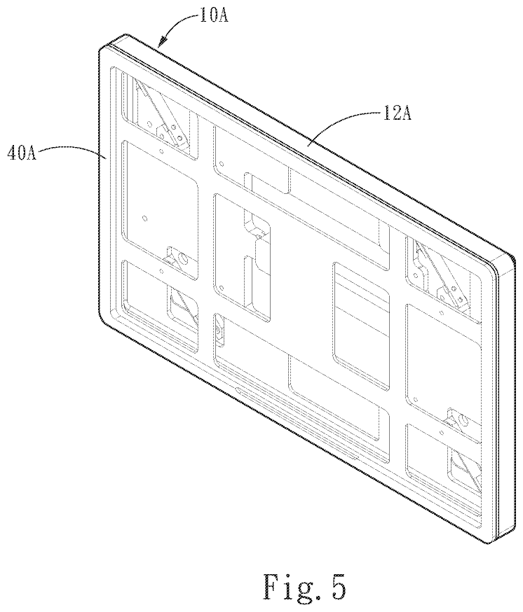

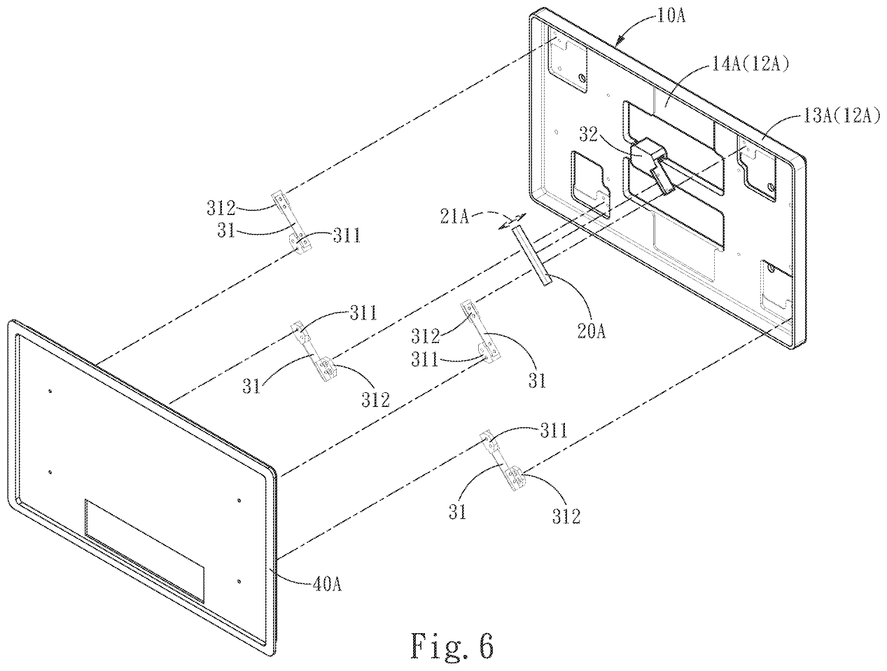

Referring to FIG. 4, FIG. 5 and FIG. 6, a second embodiment of the present invention includes a touch device 10A, and the touch device 10A includes a housing 12A and a touch panel 11A, wherein the touch panel 11A is fixed to the housing 12A by a first supporting member 40A, and the housing 12A includes a side frame 13A and a back plate 14A adhered together. In this embodiment, the touch device 10A with a size of 14 inches is taken as an example for description. When the touch device 10A with a relatively large size is applied in the present invention, more of the plurality of elastic suspension supporting members 31 need to be used. The number of the plurality of elastic suspension supporting members 31 is four, and four elastic suspension supporting members 31 are symmetrically distributed and selected to adopt leaf springs. First ends 311 of the plurality of elastic suspension supporting members 31 are fixed to the first supporting member 40A, and second ends 312 of the plurality of elastic suspension supporting members 31 are fixed to the back plate 14A (the housing 12A). Moreover, the plurality of elastic suspension supporting members 31 support the first supporting member 40A in a symmetrical distribution. Also, the actuator 20A is fixed to the touch device 10A, and more precisely, the actuator 20A is fixed to the back plate 14A (the housing 12A) by a hook buckle 32. Moreover, the actuator 20A includes a vibration force with a vibration direction 21A, and the vibration direction 21A is perpendicular to a normal direction N, a displacement direction of a buffering and resetting displacement degree of freedom of the plurality of elastic suspension supporting members 31 is parallel to the vibration direction 21A.

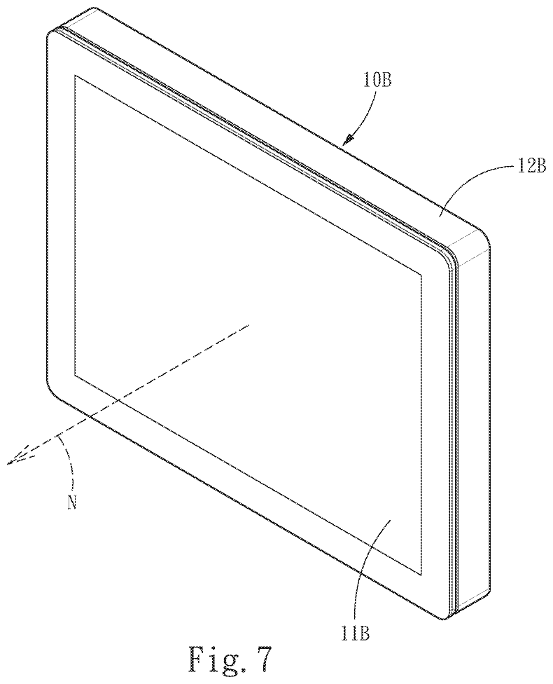

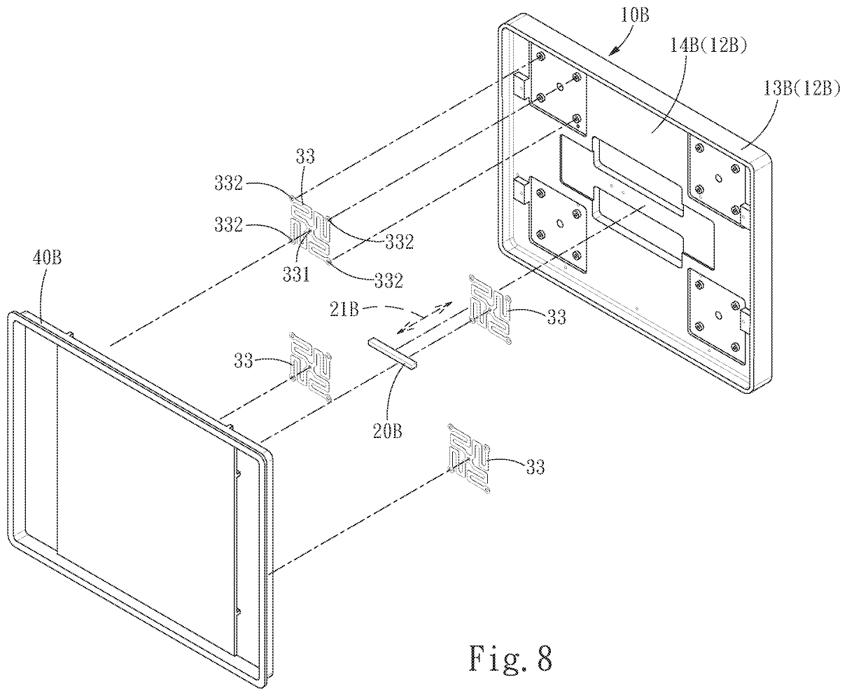

Referring to FIG. 7 and FIG. 8, a third embodiment of the present invention includes a touch device 10B, wherein a size of the touch device 10B is also 14 inches, the touch device 10B includes a housing 12B and a touch panel 11B, the touch panel 11B is fixed to the housing 12B by a first supporting member 40B, and the housing 12B includes a side frame 13B and a back plate 14B adhered together. In this embodiment, disclosing another type of elastic suspension supporting member 33 is provided, and is preferably provided with four elastic suspension supporting members 33. The elastic suspension supporting member 33 includes a first end 331 fixed to the first supporting member 40B and four second ends 332 fixed to the back plate 14B (the housing 12B). The four elastic suspension supporting members 33 support the first supporting member 40B in a symmetrical distribution. Also, the actuator 20B is fixed to the touch device 10B, more precisely, the actuator 20B is fixed to the back plate 14B (the housing 12B), and the actuator 20B includes a vibration force with a vibration direction 21B. The vibration direction 21B is parallel to a normal direction N, and a displacement direction of a buffering and resetting displacement degree of freedom of the plurality of elastic suspension supporting members 33 is parallel to the vibration direction 21B.

In summary, the present invention at least includes the following features.

1. The actuator is fixed to the touch panel or the housing of the touch device, and the vibration direction of the vibration force of the actuator is parallel to the displacement direction of the buffering and resetting displacement degree of freedom of the plurality of elastic suspension supporting members. As the vibration direction of the vibration force is the same as the displacement direction of the buffering and resetting displacement degree of freedom, interference in vibration transmission from a structure supporting point may be avoided to enable the vibration force of the actuator to be uniformly transmitted to the touch panel, so that an operator may obviously feel tactile feedback vibration of the actuator.

2. The control module controls the actuator, and the actuator is driven by the real tactile data or the sensed data, thereby enabling the actuator to have different vibration modes, vibration times or vibration strength and the like to meet different usage requirements.

3. An appropriate number of the plurality of elastic suspension supporting members are selected according to the size of the touch panel, and the elastic suspension supporting members support the touch panel in a symmetrical distribution, so as to meet the usage requirements of the touch panels with different sizes.

What is claimed is:

1. A tactile feedback device, mounted on a touch device with a touch panel and a housing, the tactile feedback device comprising:
an actuator, fixed to the touch device and providing a vibration force with a vibration direction; and
an elastic suspension supporting module, comprising a plurality of elastic suspension supporting members respectively provided with a first end fixed to the touch panel and a second end fixed to the housing, and the plurality of elastic suspension supporting members respectively provided with a buffering and resetting displacement degree of freedom with a displacement direction parallel to the vibration direction, and the plurality of elastic suspension supporting members supporting the touch panel in a symmetrical distribution.

2. The tactile feedback device of claim 1, wherein the actuator is fixed to the touch panel.

3. The tactile feedback device of claim 2, wherein the tactile feedback device further comprises a first supporting member fixed to the touch panel, and the actuator is fixed to the first supporting member.

4. The tactile feedback device of claim 1, wherein the tactile feedback device further comprises a first supporting member fixed to the touch panel, and first ends of the plurality of elastic suspension supporting members are fixed to the first supporting member.

5. The tactile feedback device of claim 1, wherein the tactile feedback device further comprises a second supporting member fixed to the housing, and second ends of the plurality of elastic suspension supporting members are fixed to the second supporting member.

6. The tactile feedback device of claim 1, wherein the tactile feedback device further comprises a control module for controlling the actuator.

7. The tactile feedback device of claim 6, wherein the control module drives the actuator based on a real tactile data.

8. The tactile feedback device of claim 6, wherein the control module drives the actuator based on a sensed data.

9. The tactile feedback device of claim 8, wherein the sensed data is generated by a sensing device disposed on the touch panel.

10. The tactile feedback device of claim 9, wherein the sensing device is any one of an infrared light pressure sensor and a multi-axis accelerometer.

11. The tactile feedback device of claim 1, wherein the actuator is selected from any one of an eccentric motor, a piezoelectric actuator, and a linear resonator.

12. The tactile feedback device of claim 1, wherein the plurality of elastic suspension supporting members are elastic structures made of plastic, metal or foam.

13. The tactile feedback device of claim 1, wherein the plurality of elastic suspension supporting members are leaf springs.

14. The tactile feedback device of claim 1, wherein the actuator is fixed to the housing.

15. The tactile feedback device of claim 14, wherein the actuator is fixed to the housing by a hook buckle.

16. The tactile feedback device of claim 1, wherein the touch panel comprises a normal direction, and the vibration direction is perpendicular to the normal direction.

17. The tactile feedback device of claim 1, wherein the touch panel comprises a normal direction, and the vibration direction is parallel to the normal direction.
